(19) United States
(12) Patent Application Publication
(10) Pub. No.: US 2008/0310319 A1
(43) Pub. Date: Dec. 18, 2008

(54) SERVER, NETWORK SYSTEM, AND NETWORK CONNECTION METHOD USED FOR THE SAME

(76) Inventors: HIROSHI KITAMURA, Tokyo (JP); Shigeyoshi Shima, Tokyo (JP); Koki Hayashi, Tokyo (JP); Tsuneo Okajima, (US)

Correspondence Address: NEC CORPORATION OF AMERICA, 6535 N. STATE HWY 161, IRVING, TX, 75039, US

(21) Appl. No.: 12/113,353

(22) Filed: May 1, 2008

(30) Foreign Application Priority Data
Jun. 13, 2007 (JP) 155809/2007

(51) Int. Cl. G06F 11/00

(52) U.S. Cl. 370/252

(57) ABSTRACT

A server includes a packet monitoring unit for monitoring a packet that is sent from a terminal without a function of automatically allocating an Internet Protocol (IP) address to a destination via an unknown network so as to detect the destined IP address of the packet; and a setting changing unit for setting the destined IP address detected by the packet monitoring unit to a self device.

### INCORPORATION BY REFERENCE

This application is based upon and claims the benefit of priority from Japanese patent applications No. 2007-155809, filed on Jun. 13, 2007, the disclosure of which is incorporated herein its entirety by reference.

### BACKGROUND OF THE INVENTION

1. Field of the Invention

The present invention relates to a server, a network system and a network connection method used for the same, and more specifically to a network connection method for a terminal without a function of automatically allocating Internet Protocol (IP) address.

2. Description of the Prior Art

As a related quarantine system, a system for rejecting communications from a terminal immediately when a terminal that failed in user authentication or a terminal with insufficient anti-virus software program is connected with a network has been known.

Such a quarantine system takes a method of dynamically changing an IP address to be allocated to a terminal according to the user authentication result or the state of its anti-virus measures.

As another quarantine system, a system for applying another IP address to a computer with a fixed IP address has been known. Patent Document 1 (Japanese Patent Laid-Open No. 2006-262141) describes the quarantine system.

In the quarantine system, a receiving server receives an Address Resolution Protocol (ARP) request packet. The packet is sent from a terminal with a peer-to-peer connection to the same Virtual LAN (Local Area Network) (VLAN) to a default gateway or the like. And then, the receiving server sets its own Media Access Control (MAC) address as the original MAC address and returns an ARP response packet to the terminal. Simultaneously the receiving server registers the IP address of the destined default gateway in a interface.

When the terminal makes IP communications to the receiving server, the receiving server transfers the packet from the terminal to the registered default gateway in place of the terminal. When the IP packet is sent from the destined IP address to the receiving server, the receiving server changes the destination to the fixed IP address of the terminal and transfers the IP packet thereto.

The related quarantine system using a method of dynamically changing an IP address to be allocated to a terminal cannot apply the method to a terminal without a function of automatically allocating an IP address. Thus, the system has a problem in that it cannot use the quarantine system to that kind of terminal. The technique described in the Patent Document also has the problem.

As a method for solving the problem, a system for enabling a function of automatically allocating an IP address of a terminal from a device other than the terminal has been known. The system, however, requires IP communications between the device that provides the system for enabling the function of automatically allocating the IP address of the terminal and the terminal without a function of automatically allocating an IP address.

It has been desired to provide the related quarantine system with a system for enabling IP communications between a terminal that does not use a function of automatically allocating an IP address and a device that provides a system for enabling a function of automatically allocating the IP address of a terminal without changing the setting of the terminal when the terminal is connected with an unknown network under the abovementioned condition.

### SUMMARY

An exemplary object of the invention is to provide a server, a network system and a network connection method used for the same that enables communications between a terminal with a fixed IP address without using a function of automatically allocating an IP address and a receiving server without changing the IP address of the terminal when the terminal is connected with an unknown network, by solving the abovementioned problem.

A server according to the present invention includes a packet monitoring unit for monitoring a packet that is sent from a terminal without a function of automatically allocating an Internet Protocol (IP) address to a destination via an unknown network so as to detect the destined IP address of the packet, and a setting changing unit for setting the destined IP address detected by the packet monitoring unit to a self device.

A network system according to the present invention includes the abovementioned server.

A network connection method according to the present invention is such that a server monitors a packet that is sent from a terminal without a function of automatically allocating an IP address to a destination via an unknown network, detects the destined Internet Protocol (IP) address of the packet, and sets the detected destined IP address to a self device.

A recording medium according to the present invention is such that a program for causing a control unit in the server to execute the processes of: monitoring a packet that is sent from a terminal without a function of automatically allocating an Internet Protocol (IP) address to a destination via an unknown network and detecting the destined IP address of the packet, and setting the detected destined IP address to a self device.

### BRIEF DESCRIPTION OF THE DRAWINGS

FIG. 1 is a scheme showing a theory of an operation of a receiving server of the present invention.

FIG. 2 is a block diagram showing an exemplary configuration of a receiving server in a network system according to a first exemplary embodiment of the present invention;

FIG. 3 is a block diagram showing an exemplary configuration of a receiving server in a network system according to a second exemplary embodiment of the present invention;

FIG. 4 is a sequence chart showing how signals are exchanged between the terminal shown in FIG. 3 and each unit of the receiving server when the terminal is connected with an IPv4 network;

FIG. 5 is a sequence chart showing how signals are exchanged between the terminal according to a third exemplary embodiment of the present invention and each unit of the receiving server when the terminal is connected with an IPv4 network;

FIG. 6 is a sequence chart showing how signals are exchanged between the terminal according to a fourth exemplary embodiment of the present invention and each unit of the receiving server when the terminal is connected with an IPv6 network;

FIG. 7 is a sequence chart showing how signals are exchanged between the terminal according to a fifth exemplary embodiment of the present invention and each unit of the receiving server when the terminal is connected with an IPv6 network;

FIG. 8 is a sequence chart showing how signals are exchanged between the terminal according to a sixth exemplary embodiment of the present invention and each unit of the receiving server when the terminal is connected with an IPv4 network or IPv6 network and then the terminal communicates with a network whose IP address is different from the IP address set in the terminal; and

FIG. 9 is a block diagram showing an exemplary configuration of a receiving server in a network system according to a seventh exemplary embodiment of the present invention.

### EXEMPLARY EMBODIMENT

In advance of describing of the exemplary embodiments of the present invention, a theory of an operation of a receiving server of the present invention is described briefly as follows.

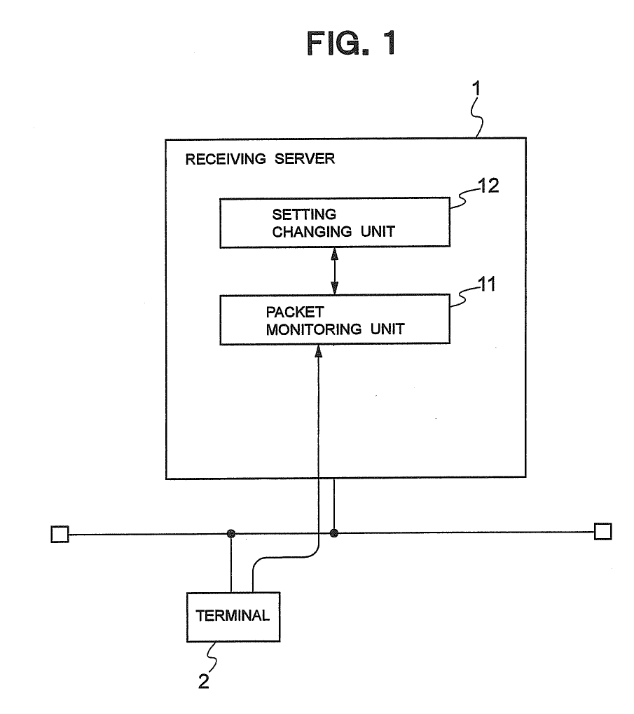

FIG. 1 is a scheme showing a theory of an operation of a receiving server of the present invention.

Referring to FIG. 1, a receiving server 1 of the present invention includes a packet monitoring unit 11 for monitoring a packet that is sent from a terminal 2 without a function of automatically allocating an Internet Protocol (IP) address to a destination via an unknown network so as to detect the destined IP address of the packet; and a setting changing unit 12 for setting the destined IP address detected by the packet monitoring unit 11 to a self device 1.

Therefore, IP communications between the terminal 2 and the receiving server 1 can be realized without changing the IP address setting of the terminal 2 by causing the receiving server 1 to monitor a packet sent from the terminal 2 and add the destined IP address of the packet to the receiving server 1 itself.

Now, exemplary embodiments of the present invention will be described with reference to the drawings.

### First Exemplary Embodiment

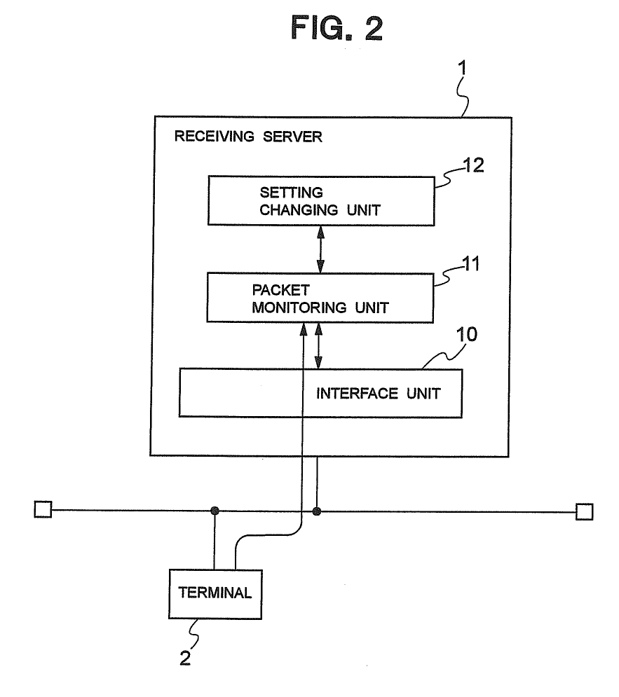

FIG. 2 is a block diagram showing an exemplary configuration of a receiving server in a network system according to the first exemplary embodiment of the present invention. In FIG. 2, the network system according to the first exemplary embodiment of the present invention includes a receiving server 1, a terminal 2, and a transmission line for connecting the receiving server 1 and the terminal 2. The receiving server 1 includes an interface 10, a packet monitoring unit 11, and a setting changing unit 12. The receiving server 1 can connect with the terminal 2 via the interface 10.

In the receiving server 1, the interface 10 is allocated with an Internet Protocol (IP) address so that it can be accessed (sent/received and monitored its state) by a Kernel module unit.

The packet monitoring unit 11 detects a destined IP address of the packet to be sent from the terminal 2, and reports the destined IP address to the setting changing unit 12. The setting changing unit 12 adds the destined IP address reported from the packet monitoring unit 11 to the interface 10 of the receiving server 1.

In this manner, the embodiment enables IP communications between the terminal 2 and the receiving server 1 without changing the IP address setting of the terminal 2 even if the terminal 2 has a fixed IP address without using a function of automatically allocating an IP address.

That is, the related art cannot enable a terminal, which has a fixed IP address without using a function of automatically allocating an IP address, to make IP communications unless the IP address setting of the terminal is changed, when the terminal is connected with an unknown network.

The embodiment enables IP communications between the terminal 2 and the receiving server 1, which has the abovementioned system, without changing the IP address setting of the terminal 2 by causing the receiving server 1 to monitor a packet sent from the terminal 2 and add the destined IP address of the packet to the interface 10 of the receiving server 1.

The embodiment provides the receiving server 1 with a function of providing a system for enabling a function of automatically allocating the IP address of the terminal 2. That enables IP communications between the terminal 2 and the receiving server 1 and makes the function of automatically allocating the IP address of the terminal 2 available. Accordingly, the embodiment can be applied to the abovementioned quarantine system related with the present invention.

An exemplary advantage according to the invention is enabling communications between a terminal, which has a fixed IP address without using a function of automatically allocating an IP address, and a receiving server without changing the IP address of the terminal if the terminal is connected with an unknown network to which the receiving server is connected, with the abovementioned configuration and operation.

### Second Exemplary Embodiment

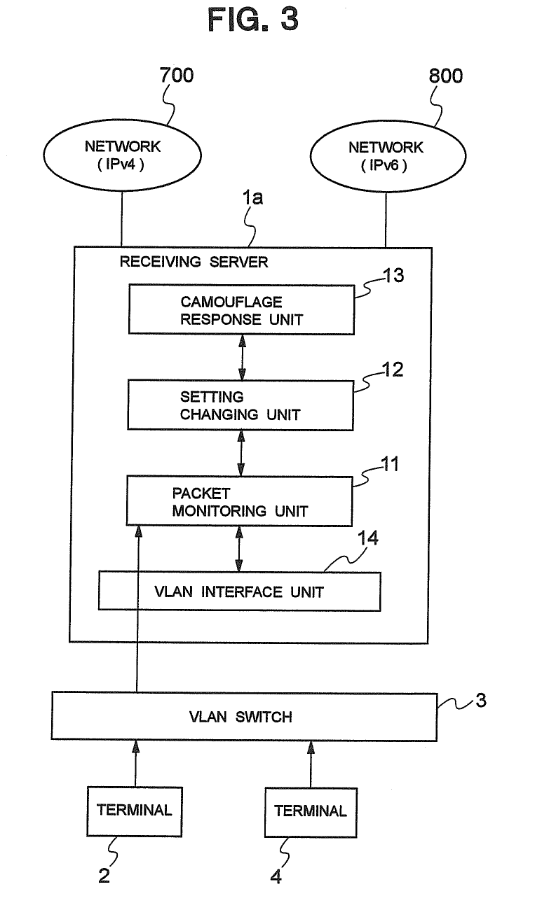

FIG. 3 is a block diagram showing an exemplary configuration of a receiving server in a network system according to the second exemplary embodiment of the present invention. In FIG. 3, the network system according to the second exemplary embodiment of the present invention includes a receiving server 1a, the terminals 2 and 4, a virtual LAN (Local Area Network) (VLAN) switch 3 for connecting the terminals 2 and 4 and the receiving server 1a, and an IP version 4 (IPv4) network 700 or an IP Version 6 (IPv6) network 800.

The receiving server 1a includes the packet monitoring unit 11, the setting changing unit 12, a camouflage response unit 13, and a VLAN interface 14. The receiving server 1a can connect with the terminal 2 via the VLAN interface 14.

The VLAN switch 3 divides a network by using the VLAN for each of the terminals 2 and 4 to be connected so as to prevent the terminal 2 and the terminal 4 from communicating with each other. The VLAN switch 3 includes the receiving server 1a in the same VLAN as that of the terminal 2 so as to enable peer-to-peer communications between the terminal 2 and the receiving server 1a.

The VLAN including the terminal 2 and the receiving server 1a has no terminal other than the terminal 2 when the destined IP address of a packet sent from the terminal 2 is added to the VLAN interface 14 of the receiving server 1a. Therefore, the receiving server 1a can add an IP address to the VLAN interface 14 without causing any redundancy of IP addresses.

The packet monitoring unit 11 monitors the packet sent from the terminal 2, detects a destined IP address in the packet, and reports the destined IP address to the setting changing unit 12. The setting changing unit 12 adds the destined IP address reported from the packet monitoring unit 11 to the VLAN interface 14 of the receiving server 1a.

In response to the Address Resolution Protocol (ARP) request packet or a Neighbor Solicitation (NS) message from the terminal 2 that is received by the packet monitoring unit 11, the camouflage response unit 13 adds Media Access Control address (MAC address) or a link layer address of the receiving server 1a to a response packet and returns a response to the terminal 2.

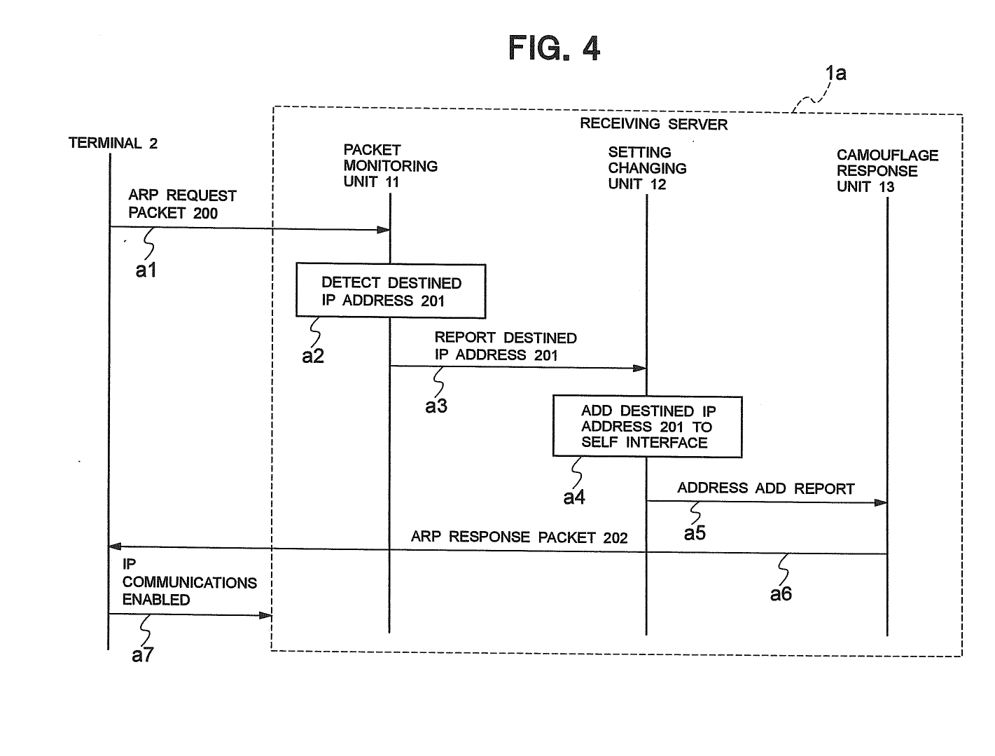

FIG. 4 is a sequence chart showing how signals are exchanged between the terminal 2 shown in FIG. 3 and each unit of the receiving server 1a (packet monitoring unit 11, setting changing unit 12, camouflage response unit 13) when the terminal 2 is connected with an IPv4 network 700. Operation performed by the network system according to the second embodiment of the present invention will be described with reference to FIG. 3 and FIG. 4.

FIG. 4 shows signal exchange from when the terminal 2 is connected with the network 700 until the terminal 2 sends an ARP request packet 200 so that IP communications from the terminal 2 to the receiving server 1a become available.

When the terminal 2 has IP addresses of a default gateway, a Domain Name Server (DNS) server, and a proxy server set and is connected with the network 700, the terminal 2 sends an ARP packet [an ARP other than the ARP (Gratuitous ARP) destined to itself] to the network 700 (a1 of FIG. 4).

The packet monitoring unit 11 monitors a packet, and when it receives the ARP request packet 200 sent from the terminal 2, it detects the destined IP address 201 from the ARP request packet 200 (a2 of FIG. 4). The packet monitoring unit 11 reports the detected destined IP address 201 to the setting changing unit 12 (a3 of FIG. 4).

The setting changing unit 12 adds the reported destined IP address 201 to the VLAN interface 14 of the receiving server 1a that received the ARP request packet 200 (a4 of FIG. 4), and sends an address add report for reporting that the destined IP address 201 is added to the VLAN interface 14 of the receiving server 1a to the camouflage response unit 13 (a5 of FIG. 4).

In response to the ARP request packet 200 that is received by the packet monitoring unit 11, the camouflage response unit 13 sets the MAC address of the receiving server 1a to the original MAC address of an ARP response packet 202 and returns the ARP response packet 202 to the terminal 2 (a6 of FIG. 4).

The terminal 2 recognizes the MAC address and the IP address of the receiving server 1a according to the original MAC address and the original IP address of the ARP response packet 202 received from the receiving server 1A. As the ARP response is sent to solve the issue of the MAC address to the IP address to which the ARP request sending side is to communicate, the IP address added by the receiving server 1a to the VLAN interface 14 is the IP address with which the terminal 2 is to communicate. Therefore, IP communications from the terminal 2 to the receiving server 1a become available (a7 of FIG. 4).

As such, the embodiment has the receiving server 1a having a function of monitoring a packet sent by the terminal 2 and adding the destined IP address of the packet to the VLAN interface 14 of the receiving server 1a. Therefore, the embodiment enables IP communications between the terminal 2 and the receiving server 1a without changing the IP address of the terminal 2 when the terminal 2 has a fixed IP address without using a function of automatically allocating an IP address and connects to the unknown network 700 to which the receiving server 1a is connected.

As the embodiment needs not to change the IP address of the terminal 2, information on the unknown network 700 needs not to be obtained and setting of the terminal 2 needs not to be manually changed.

An exemplary advantage according to the invention is that the embodiment provides the receiving server 1a with a function of providing a system for enabling a function of automatically allocating the IP address of the terminal 2. That enables IP communications between the terminal 2 and the receiving server 1a and makes the function of automatically allocating the IP address of the terminal 2 available. Accordingly, the embodiment can be applied to the abovementioned quarantine system related with the present invention.

### Third Exemplary Embodiment

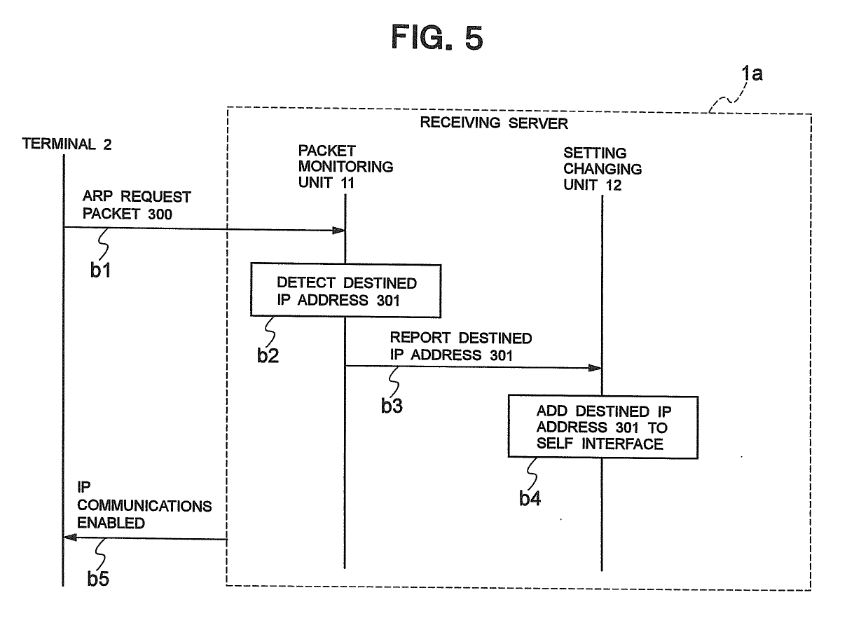

FIG. 5 is a sequence chart showing how signals are exchanged between the terminal according to the third exemplary embodiment of the present invention and each unit of the receiving server (a packet monitoring unit, a setting changing unit) when the terminal is connected with an IPv4 network. The network system according to the third exemplary embodiment of the present invention has the same configuration as that of the network system according to the second exemplary embodiment of the present invention shown in FIG. 3. Operation performed by the network system according to the third exemplary embodiment of the present invention will be described with reference to FIG. 3 and FIG. 5.

FIG. 5 shows signal exchange from when the terminal 2 is connected with the network 700 until the terminal 2 sends an ARP request packet 300 so that IP communications from the receiving server 1a to the terminal 2 become available.

When the terminal 2 has IP addresses of a default gateway, a DNS server, and a proxy server set and is connected with the network 700, the terminal 2 sends an ARP request packet 300 to the network 700 (b1 of FIG. 5).

The packet monitoring unit 11 monitors a packet, and when it receives the ARP request packet 300 sent from the terminal 2, it detects the destined IP address 301 from the ARP request packet 300 (b2 of FIG. 5). The packet monitoring unit 11 reports the detected destined IP address 301 to the setting changing unit 12 (b3 of FIG. 5).

The setting changing unit 12 adds the reported destined IP address 301 to the VLAN interface 14 of the receiving server 1a that received the ARP request packet 300 (b4 of FIG. 4).

The receiving server 1a can obtain the MAC address and the IP address of the terminal 2 according to the original MAC address and the original IP address of the ARP request packet 300. As the IP address with which the terminal 2 is to communicate is added to the VLAN interface 14 of the receiving server 1a, IP communications from the receiving server 1a to the terminal 2 become available (b5 of FIG. 5).

As such, the embodiment has the receiving server 1a having a function of monitoring a packet sent by the terminal 2 and adding the destined IP address of the packet to the VLAN interface 14 of the receiving server 1a. Therefore, the embodiment enables IP communications between the terminal 2 and the receiving server 1a without changing the IP address of the terminal 2 when the terminal 2 has a fixed IP address without using a function of automatically allocating an IP address and connects to the unknown network 700 to which the receiving server 1a is connected.

As the embodiment needs not to change the IP address of the terminal 2, information on the unknown network 700 needs not to be obtained and setting of the terminal 2 needs not to be manually changed.

An exemplary advantage according to the invention is that the embodiment provides the receiving server 1a with a function of providing a system for enabling a function of automatically allocating the IP address of the terminal 2. That enables IP communications between the terminal 2 and the receiving server 1a and makes the function of automatically allocating the IP address of the terminal 2 available. Accordingly, the embodiment can be applied to the abovementioned quarantine system related with the present invention.

### Fourth Exemplary Embodiment

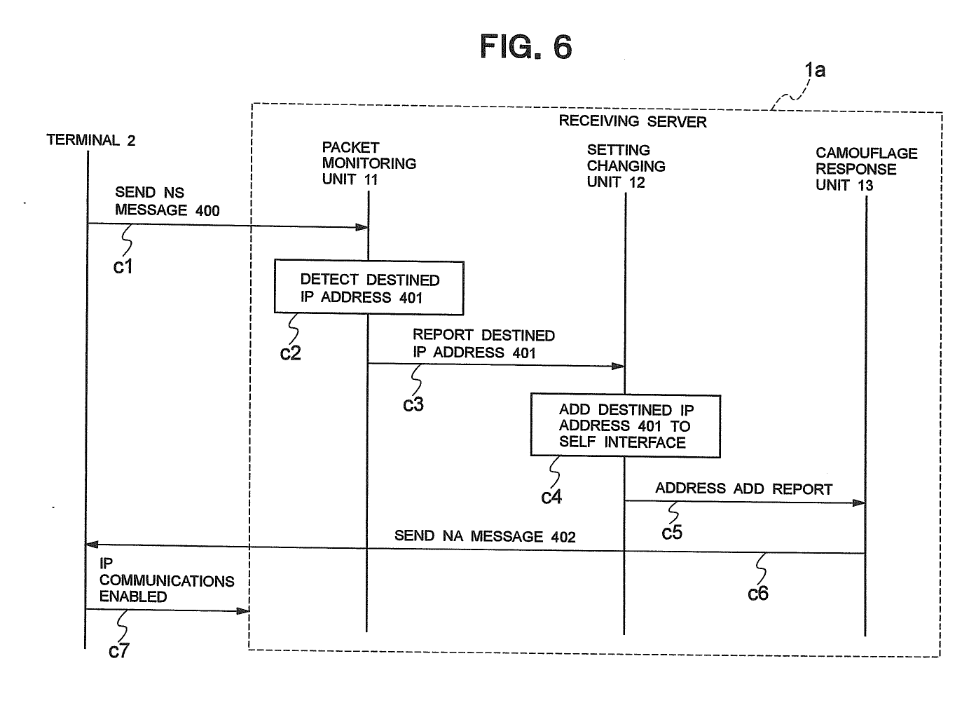

FIG. 6 is a sequence chart showing how signals are exchanged between the terminal according to the fourth exemplary embodiment of the present invention and each unit of the receiving server (a packet monitoring unit, a setting changing unit, a camouflage response unit) when the terminal is connected with an IPv6 network. The network system according to the fourth exemplary embodiment of the present invention has the same configuration as that of the network system according to the second exemplary embodiment of the present invention shown in FIG. 3. Operation performed by the network system according to the fourth exemplary embodiment of the present invention will be described with reference to FIG. 3 and FIG. 6.

FIG. 6 shows signal exchange from when the terminal 2 is connected with a network 800 until the terminal 2 sends a Neighbor Solicitation (NS) message 400 so that IP communications from the terminal 2 to the receiving server 1a become available.

When only the IP address is known and a link layer address is to be obtained in the IPv6, the NS message is sent to the destined IP address, and a node which is to respond to the NS message sends the link layer address of the self node on the Neighbor Advertisement (NA) message to solve the issue of the link layer address.

If the terminal 2 has IP addresses of a default gateway, a DNS server, and a proxy server set when the terminal 2 is to be connected with the network 800, the terminal 2 sends an NS message 400 to the network 800 (c1 of FIG. 6).

The packet monitoring unit 11 monitors a packet, and when it receives the NS message 400 sent from the terminal 2, it detects the destined IP address 401 from the NS message 400 (c2 of FIG. 6). The packet monitoring unit 11 reports the detected destined IP address 401 to the setting changing unit 12 (c3 of FIG. 6).

The setting changing unit 12 adds the reported destined IP address 401 to the VLAN interface 14 of the receiving server 1a that received the NS message 400 (c4 of FIG. 6), and sends an address add report for reporting that the destined IP address 401 is added to the VLAN interface 14 of the receiving server 1a to the camouflage response unit 13 (c5 of FIG. 6).

In response to the NS message 400 from the terminal 2 that is received by the packet monitoring unit 11, the camouflage response unit 13 sends an NA message 402 including the link layer address of the receiving server 1a to the terminal 2 (c6 of FIG. 6).

The terminal 2 recognizes the link layer address and the IP address of the receiving server 1a according to the NA message received from the receiving server 1a. As the IP address of the receiving server 1a is the IP address with which the terminal 2 is to communicate, IP communications from the terminal 2 to the receiving server 1a become available (c7 of FIG. 6).

As such, the embodiment has the receiving server 1a having a function of monitoring a packet sent by the terminal 2 and adding the destined IP address of the packet to the VLAN interface 14 of the receiving server 1a. Therefore, the embodiment enables IP communications between the terminal 2 and the receiving server 1a without changing the IP address of the terminal 2 when the terminal 2 has a fixed IP address without using a function of automatically allocating an IP address and connects to the unknown network 800 to which the receiving server 1a is connected.

As the embodiment needs not to change the IP address of the terminal 2, information on the unknown network 800 needs not to be obtained and setting of the terminal 2 needs not to be manually changed.

An exemplary advantage according to the invention is that the embodiment provides the receiving server 1a with a function of providing a system for enabling a function of automatically allocating the IP address of the terminal 2. That enables IP communications between the terminal 2 and the receiving server 1a and enables the function of automatically allocating the IP address of the terminal 2. Accordingly, the embodiment can be applied to the abovementioned quarantine system related with the present invention.

### Fifth Exemplary Embodiment

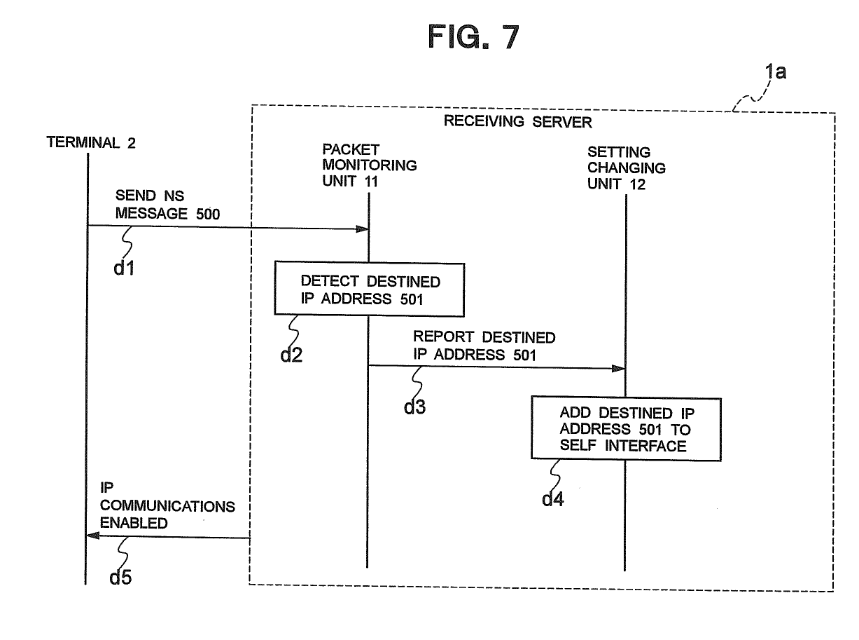

FIG. 7 is a sequence chart showing how signals are exchanged between the terminal according to the fifth exemplary embodiment of the present invention and each unit of the receiving server (a packet monitoring unit, a setting changing unit) when the terminal is connected with an IPv6 network. The network system according to the fifth exemplary embodiment of the present invention has the same configuration as that of the network system according to the second exemplary embodiment of the present invention shown in FIG. 3. Operation performed by the network system according to the fifth exemplary embodiment of the present invention will be described with reference to FIG. 3 and FIG. 7.

FIG. 7 shows signal exchange from when the terminal 2 is connected with the network 800 until the terminal 2 sends an NS message 500 so that IP communications from the receiving server 1a to the terminal 2 become available.

When the terminal 2 has IP addresses of a default gateway, a DNS server, and a proxy server set and is connected with the network 800, the terminal 2 sends an NS message 500 to the network 800 (d1 of FIG. 7).

The packet monitoring unit 11 monitors a packet, and when it receives the NS message 500 sent from the terminal 2, it detects the destined IP address 501 from the NS message 500 (d2 of FIG. 7). The packet monitoring unit 11 reports the detected destined IP address 501 to the setting changing unit 12 (d3 of FIG. 7).

The setting changing unit 12 adds the reported destined IP address 501 to the VLAN interface 14 of the receiving server 1a that received the NS message 500 (d4 of FIG. 7).

The setting changing unit 12 can obtain the link layer address and the IP address of the terminal 2 according to the link layer address and the original IP address of the NS message 500. As the IP address with which the terminal 2 is to communicate is added to the VLAN interface 14 of the receiving server 1a, IP communications from the receiving server 1a to the terminal 2 become available (d5 of FIG. 7).

As such, the embodiment has the receiving server 1a having a function of monitoring a packet sent by the terminal 2 and adding the destined IP address of the packet to the VLAN interface 14 of the receiving server 1a. Therefore, the embodiment enables IP communications between the terminal 2 and the receiving server 1a without changing the IP address of the terminal 2 when the terminal 2 has a fixed IP address without using a function of automatically allocating an IP address and connects to the unknown network 800 to which the receiving server 1a is connected.

As the embodiment needs not to change the IP address of the terminal 2, information on the unknown network 800 needs not to be obtained and setting of the terminal 2 needs not to be manually changed.

An exemplary advantage according to the invention is that the embodiment provides the receiving server 1a with a function of providing a system for enabling a function of automatically allocating the IP address of the terminal 2. That enables IP communications between the terminal 2 and the receiving server 1a and enables the function of automatically allocating the IP address of the terminal 2. Accordingly, the embodiment can be applied to the abovementioned quarantine system related with the present invention.

### Sixth Exemplary Embodiment

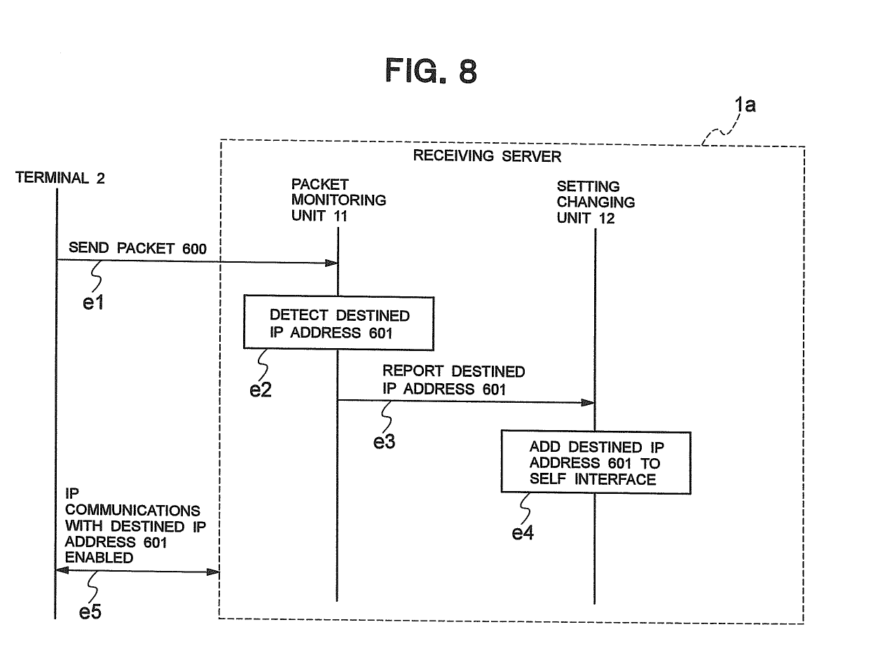

FIG. 8 is a sequence chart showing how signals are exchanged between the terminal according to the sixth exemplary embodiment of the present invention and each unit of the receiving server (a packet monitoring unit, a setting changing unit) when the terminal is connected with an IPv4 network or an IPv6 network. The network system according to the sixth exemplary embodiment of the present invention has the same configuration as that of the network system according to the second exemplary embodiment of the present invention shown in FIG. 3. Operation performed by the network system according to the sixth exemplary embodiment of the present invention will be described with reference to FIG. 3 and FIG. 8.

FIG. 8 shows signal exchange from when the terminal 2 is connected with the network 700 or the network 800 until the terminal 2 is to communicate with a network which is different from that at the IP address set in the terminal 2 (the network needs to be communicated through a router). That is, FIG. 8 shows signal exchange from when the terminal 2 sends a packet 600 until IP communications between the terminal 2 and the server at the destined IP address 601 of the packet 600 become available.

In FIG. 8, it is assumed that the IP address of the default gateway set in the terminal 2 is added to the VLAN interface 14 of the receiving server 1a according to the abovementioned operation shown in FIG. 4 to FIG. 7.

When the terminal 2 has an IP address of a network different from those of a DNS server and a proxy server set and is connected with the network 700 or the network 800, the terminal 2 sends a packet 600 to the default gateway (receiving server 1a) (e1 of FIG. 8).

The packet monitoring unit 11 monitors a packet, and when it receives the packet 600 sent from the terminal 2, it detects the destined IP address 601 from the packet 600 (e2 of FIG. 8). The packet monitoring unit 11 reports the detected destined IP address 601 to the setting changing unit 12 (e3 of FIG. 8). The setting changing unit 12 adds the reported destined IP address 601 to the VLAN interface 14 of the receiving server 1a (e4 of FIG. 8).

As the IP address of the default gateway of the terminal 2 and the destined IP address of the packet 600 are given to the VLAN interface 14 of the receiving server 1a, IP communications are enabled between the terminal 2 and the server at the destined IP address 601 (receiving server 1a) (e5 of FIG. 8).

As such, the embodiment has the receiving server 1a having a function of monitoring a packet sent by the terminal 2 and adding the destined IP address of the packet to the VLAN interface 14 of the receiving server 1a. Therefore, the embodiment enables IP communications between the terminal 2 and the receiving server 1a without changing the IP address of the terminal 2 when the terminal 2 has a fixed IP address without using a function of automatically allocating an IP address and connects to the unknown network 700 or the network 800 to which the receiving server 1a is connected.

As the embodiment needs not to change the IP address of the terminal 2, information on the unknown network 700 or the network 800 needs not to be obtained and setting of the terminal 2 needs not to be manually changed.

An exemplary advantage according to the invention is that the embodiment provides the receiving server 1a with a function of providing a system for enabling a function of automatically allocating the IP address of the terminal 2. That enables IP communications between the terminal 2 and the receiving server 1a and enables the function of automatically allocating the IP address of the terminal 2. Accordingly, the embodiment can be applied to the abovementioned quarantine system related with the present invention.

### Seventh Exemplary Embodiment

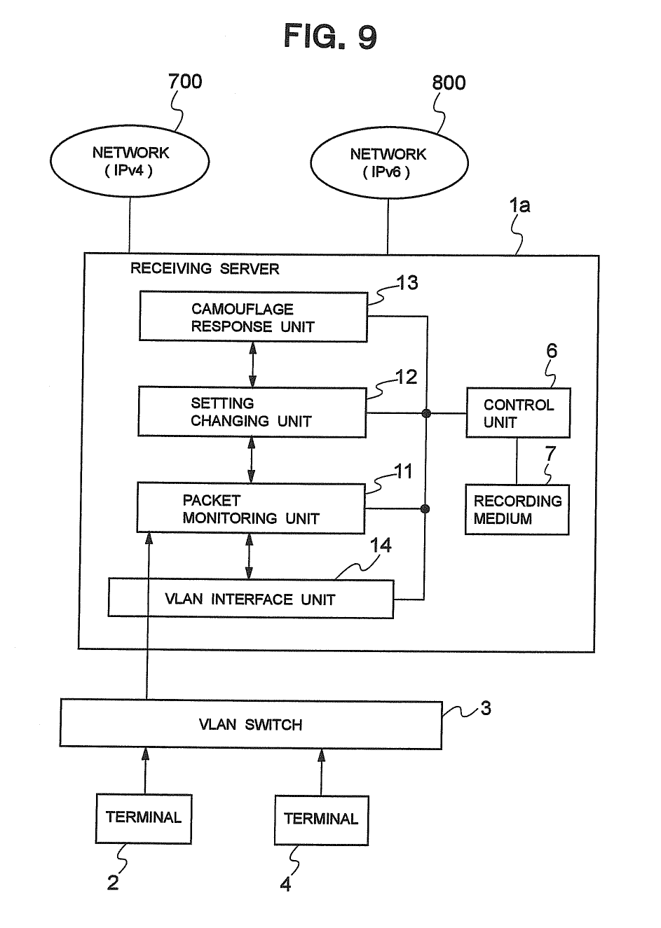

FIG. 9 is a block diagram showing an exemplary configuration of a receiving server in a network system according to a seventh exemplary embodiment of the present invention. In FIG. 9, the network system according to the seventh exemplary embodiment of the present invention is the configuration according to the second exemplary embodiment (see FIG. 3) with a control unit 6 and a recording medium 7 added. As operation performed by the components of the seventh exemplary embodiment is the same as that performed by the components of the second exemplary embodiment, only operation performed by the newly added control unit 6 and recording medium 7 will be described.

Referring to FIG. 9, the control unit 6 controls over the packet monitoring unit 11, the setting changing unit 12, the camouflage response unit 13, and the VLAN interface 14.

The recording medium 7 records a program for causing a computer to execute the network connection method shown in the sequence charts in FIG. 4 to FIG. 8. The control unit (computer) 6 reads out the program from the recording medium 7 and controls over the units 11 to 14 according to the program. As the control has already been described above, it will be omitted from the description below.

An exemplary advantage according to the invention is that the embodiment provides a program for providing the receiving server 1a with a system for enabling a function of automatically allocating the IP address of the terminal 2.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A server comprising:
a packet monitoring unit for monitoring a packet that is sent from a terminal without a function of automatically allocating an Internet Protocol (IP) address to a destination via an unknown network so as to detect the destined IP address of the packet; and
a setting changing unit for setting the destined IP address detected by said packet monitoring unit to a self device.

2. The server according to claim 1, wherein, when said unknown network is an IP version 4 (IPv4) network, said setting changing unit sets the destined IP address that is detected by said packet monitoring unit from an Address Resolution Protocol (ARP) request packet sent from said terminal to the self device.

3. The server according to claim 2, further comprising a camouflage response unit for adding an Media Access Control (MAC) address of the self device to a response packet and returning the response packet to said terminal in response to said ARP request packet when that said destined IP address is set to a self device is reported from said setting changing unit.

4. The server according to claim 2, wherein said setting changing unit sets said destined IP address to the interface that received said ARP request packet.

5. The server according to claim 1, wherein, when said unknown network is an IP version 6 (IPv6) network, said setting changing unit sets the destined IP address that is detected by said packet monitoring unit from a Neighbor Solicitation (NS) message sent from said terminal to the self device.

6. The server according to claim 5, further comprising a camouflage response unit for adding a link layer address to said NS message and returning said NS message to said terminal, when said setting changing unit reports that said destined IP address is set to the self device.

7. The server according to claim 5, wherein said setting changing unit sets said destined IP address to the interface that received said NS message.

8. The server according to claim 1, wherein said setting changing unit sets the destined IP address that is detected by said packet monitoring unit from a packet sent from said terminal to the self device when the terminal is connected with an IP version 4 (IPv4) network or an IP version 6 (IPv6) network and then said terminal communicates with a network whose IP address is different from the IP address set in the terminal.

9. The server according to claim 8, wherein said setting changing unit sets said destined IP address to the interface that received said packet.

10. A network system comprising the server according to claim 1.

11. A network connection method of a server, said server comprising:
monitoring a packet that is sent from a terminal without a function of automatically allocating an Internet Protocol (IP) address to a destination via an unknown network and detecting the destined IP address of the packet; and
setting the detected destined IP address to a self device.

12. The network connection method according to claim 11, wherein, when said unknown network is an IP version 4 (IPv4) network, said server sets the destined IP address that is detected from an Address Resolution Protocol (ARP) request packet sent from said terminal in said monitoring process to said server, in said setting process.

13. The network connection method according to claim 12, wherein said server executes camouflage responding process for adding an Media Access Control (MAC) address of said server to a response packet and returning the response packet to said terminal in response to said ARP request packet when that said destined IP address is set to said server is reported in said setting process.

14. The network connection method according to claim 12, wherein said server sets said destined IP address to the interface that received said ARP request packet in said setting process.

15. The network connection method according to claim 11, wherein, when said unknown network is an IP version 6 (IPv6) network, said server sets the destined IP address that is detected from a Neighbor Solicitation (NS) message sent from said terminal in said monitoring process to said server, in said setting process.

16. The network connection method according to claim 15, wherein said server executes camouflage responding for adding a link layer address to a response packet and returning said response packet to said terminal in response to said NS message, when that said destined IP address is set to said server is reported in said setting process.

17. The network connection method according to claim 15, wherein said server sets said destined IP address to the interface that received said NS message in said setting process.

18. The network connection method according to claim 11, wherein said server sets the destined IP address that is detected from a packet sent from said terminal in said packet monitoring process to said server when the terminal is connected with an IP version 4 (IPv4) network or an IP version 6 (IPv6) network and then said terminal communicates with a network whose IP address is different from the IP address set in the terminal, in said setting process.

19. The network connection method according to claim 18, wherein said server sets said destined IP address to the interface that received said packet, in said setting process.

20. A recording medium that records a program for causing a control unit in a server to execute:
monitoring a packet that is sent from a terminal without a function of automatically allocating an Internet Protocol (IP) address to a destination via an unknown network and detecting the destined IP address of the packet; and
setting the detected destined IP address to a self device.

21. A server comprising:
packet monitoring means for monitoring a packet that is sent from a terminal without a function of automatically allocating an Internet Protocol (IP) address to a destination via an unknown network so as to detect the destined IP address of the packet; and
setting changing means for setting the destined IP address detected by said packet monitoring means to a self device.
